(19) United States
(12) Patent Application Publication
(10) Pub. No.: US 2016/0359718 A1
(43) Pub. Date: Dec. 8, 2016

(54) METHOD FOR CALIBRATING AN OVER-THE-AIR (OTA) TEST SYSTEM FOR TESTING MULTIPLE RADIO FREQUENCY (RF) DATA PACKET SIGNAL TRANSCEIVERS

(71) Applicant: LITEPOINT CORPORATION, Sunnyvale, CA (US)

(72) Inventors: Soumyadeep BANERJEE, Arlington Heights, IL (US); Steve Lawrence Sheya, Vernon Hills, IL (US); Ramakrishna Yellapantula, Vernon Hills, IL (US)

(21) Appl. No.: 14/732,236

(22) Filed: Jun. 5, 2015

(51) Int. Cl. H04L 12/26; H04B 17/309

(52) U.S. Cl. CPC H04L 43/50; H04B 17/309

(57) ABSTRACT

Method for calibrating an over-the air (OTA) test system for testing multiple radio frequency (RF) data packet signal transceiver devices under test (DUTs), as well as using such a calibrated OTA test system for performing such tests. Calibration is achieved by placing a known good device (KGD) in multiple defined locations within the OTA test system, radiating the KGD with RF test signals at each location, and collecting from the KGD at each location channel quality information identifying optimal RF test signal sub-band channels for ensuring reliable communications within the test system. Use of such system includes placing multiple DUTs at the defined locations within the OTA test system and communicating with them wirelessly via the identified optimal RF test signal sub-band channels.

### BACKGROUND

The present invention relates to testing of one or more of multiple radio frequency (RF) data packet signal transceiver devices under test (DUTs) in a wireless signal test environment, and in particular, to calibrating and using a wireless signal test environment for testing multiple DUTs.

Many of today's electronic devices use wireless signal technologies for both connectivity and communications purposes. Because wireless devices transmit and receive electromagnetic energy, and because two or more wireless devices have the potential of interfering with the operations of one another by virtue of their signal frequencies and power spectral densities, these devices and their wireless signal technologies must adhere to various wireless signal technology standard specifications.

When designing such wireless devices, engineers take extra care to ensure that such devices will meet or exceed each of their included wireless signal technology prescribed standard-based specifications. Furthermore, when these devices are later being manufactured in quantity, they are tested to ensure that manufacturing defects will not cause improper operation, including their adherence to the included wireless signal technology standard-based specifications.

One common and widely used example of such devices is mobile, or cellular, telephone system that complies with the Third Generation Partnership Project (3GPP) Long Term Evolution (LTE) standard, used for voice and data communications (e.g., sending and receiving of text messages, Internet browsing, etc.). Such devices are produced in large quantities and must be individually tested during manufacturing, as well as after the actual manufacturing process prior to final shipment and sale, in which case such testing must generally be performed in a radiative, or wireless, signal environment.

One common way to perform wireless testing of post-production devices is to create an Over-T-Air (OTA) test environment, typically in the form of a shielded enclosure (e.g., metal) to confine propagation of any test signals between the test equipment and the DUTs. This will confine the test signals to within the OTA test environment and shield the DUTs from electromagnetic interference (EMI) from other signal sources, such as sources outside of the OTA test enclosure.

Such metallic enclosures can be effective at isolating the interior from EMI. However, even if the interior is designed to include anechoic chamber characteristics, the interior will nonetheless provide a multipath signal environment for the radiated signals within the enclosure. Accordingly, depending upon where a DUT is located within the enclosure, such multipath effects will be different because of the different angles from which signals will arrive at and emanate from a DUT, as well as different phases of the signals due to the different lengths of signal paths they have travelled.

Mitigating or compensating for such multipath signal effects upon the data packet test signals can be achieved by design of a calibration algorithm that takes into effect the positions of the DUT and source of test signals within the enclosure (e.g., one or more antennas). However, the variables associated with such a calibration algorithm will be different depending upon the position of the DUT as well as the presence of other DUTs within the enclosure.

Accordingly, it would be desirable to have a technique for wirelessly testing multiple DUTs in a shielded OTA environment without requiring design of custom calibration algorithms requiring, potentially, constant monitoring and revisions.

### SUMMARY

In accordance with the presently claimed invention, a method is provided for calibrating an over-the air (OTA) test system for testing multiple radio frequency (RF) data packet signal transceiver devices under test (DUTs), as well as using such a calibrated OTA test system for performing such tests. Calibration is achieved by placing a known good device (KGD) in multiple defined locations within the OTA test system, radiating the KGD with RF test signals at each location, and collecting from the KGD at each location channel quality information identifying optimal RF test signal sub-band channels for ensuring reliable communications within the test system. Use of such system includes placing multiple DUTs at the defined locations within the OTA test system and communicating with them wirelessly via the identified optimal RF test signal sub-band channels.

In accordance with one embodiment of the presently claimed invention, a method for calibrating an over-the air (OTA) test system for testing a plurality of radio frequency (RF) data packet signal transceiver devices under test (DUTs) includes:

providing an OTA test environment including a structure defining interior and exterior regions and one or more RF antennas disposed to transmit and receive radiated RF signals into and from the interior region, respectively, and configured to enable placement of a plurality of DUTs at locations within the interior region substantially isolated from electromagnetic radiation originating from the exterior region;

placing a known good device (KGD) in a defined location within the interior region;

transmitting, into the interior region via the one or more RF antennas, a RF test signal having a RF test signal band including a plurality of RF test signal sub-band channels to convey a plurality of encoded data symbols, wherein

each one of the plurality of RF test signal sub-band channels includes a plurality of serial time slots each of which contains one or more RF data signals, and

respective portions of the plurality of RF test signal sub-band channels include mutually distinct combinations of data bit modulation and quantity of data bits;

receiving, with the KGD, the RF test signal and in response thereto transmitting, with the KGD, a RF DUT signal including a plurality of channel quality information (CQI) data related to the defined location for at least a portion of the plurality of RF test signal sub-band channels, wherein respective portions of the plurality of CQI data are related to respective signal-to-interference-plus-noise ratios (SINRs) for corresponding portions of the plurality of RF test signal sub-band channels; and

placing the known good device (KGD) in another defined location within the interior region, followed by repeating the

transmitting, into the interior region via the one or more RF antennas, a RF test signal, and

receiving, with the KGD, the RF test signal and in response thereto transmitting, with the KGD, a RF DUT signal.

In accordance with another embodiment of the presently claimed invention, a method for using a calibrated over-the air (OTA) test system for testing a plurality of radio frequency (RF) data packet signal transceiver devices under test (DUTs) includes:

providing an OTA test environment including a structure defining interior and exterior regions and one or more RF antennas disposed to transmit and receive radiated RF signals into and from the interior region, respectively, and configured for placement of a plurality of DUTs at corresponding defined locations within the interior region substantially isolated from electromagnetic radiation originating from the exterior region;

placing the plurality of DUTs at the corresponding defined locations;

transmitting, into the interior region via the one or more RF antennas, a RF test signal having a RF test signal band including a plurality of RF test signal sub-band channels to convey a plurality of encoded data symbols, wherein

each one of the plurality of RF test signal sub-band channels includes a plurality of serial time slots each of which contains one or more RF data signals, and

respective portions of the plurality of RF test signal sub-band channels include mutually distinct combinations of data bit modulation and number of data bits; and

receiving, with each one of the plurality of DUTs, at least a respective portion of the RF test signal including one or more combinations of data bit modulation and number of data bits associated with the corresponding defined location, and in response thereto transmitting, with the each one of the plurality of DUTs, a RF DUT signal.

### BRIEF DESCRIPTION OF THE DRAWINGS

FIG. 1 depicts an exemplary embodiment of an OTA testing environment for multiple DUTs in accordance with the presently claimed invention.

FIG. 2 depicts a downlink resource grid in accordance with the LTE standard.

FIG. 3 depicts is a table identifying LTE sub-band size versus system bandwidth.

FIG. 4 is the four-bit channel quality information table for LTE.

FIG. 5 is the modulation and transport block size index table for the physical downlink shared channel (PDSCH) for LTE.

FIGS. 6A-6J are the transport block size table for LTE.

FIG. 7 is the modulation and transport block size index table for the physical uplink shared channel (PUSCH) for LTE.

FIG. 8 depicts exemplary results of computations for a number of resource blocks, modulation and coding scheme (MCS), and transport block size (TBS) determinations for downlink and uplink communications.

### DETAILED DESCRIPTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry.

Wireless devices, such as cellphones, smartphones, tablets, etc., make use of standards-based technologies (e.g., IEEE 802.11a/b/g/n/ac, 3GPP LTE, and Bluetooth). The standards that underlie these technologies are designed to provide reliable wireless connectivity and/or communications. The standards prescribe physical and higher-level specifications generally designed to be energy-efficient and to minimize interference among devices using the same or other technologies that are adjacent to or share the wireless spectrum.

Tests prescribed by these standards are meant to ensure that such devices are designed to conform to the standard-prescribed specifications, and that manufactured devices continue to conform to those prescribed specifications. Most devices are transceivers, containing at least one or more receivers and transmitters. Thus, the tests are intended to confirm whether the receivers and transmitters both conform. Tests of the receiver or receivers (RX tests) of a DUT typically involve a test system (tester) sending test packets to the receiver(s) and some way of determining how the DUT receiver(s) respond to those test packets. Transmitters of a DUT are tested by having them send packets to the test system, which then evaluates the physical characteristics of the signals sent by the DUT.

For example, testing of wireless devices typically involves testing of the receiving and transmitting subsystems of each device. Receiver subsystem testing includes sending a prescribed sequence of test data packet signals to a DUT using different frequencies, power levels, and/or modulation types to determine if its receiving subsystem is operating properly. Similarly, transmitting subsystem testing includes having the DUT send test data packet signals at a variety of frequencies, power levels, and/or modulation types to determine if its transmitting subsystem is operating properly.

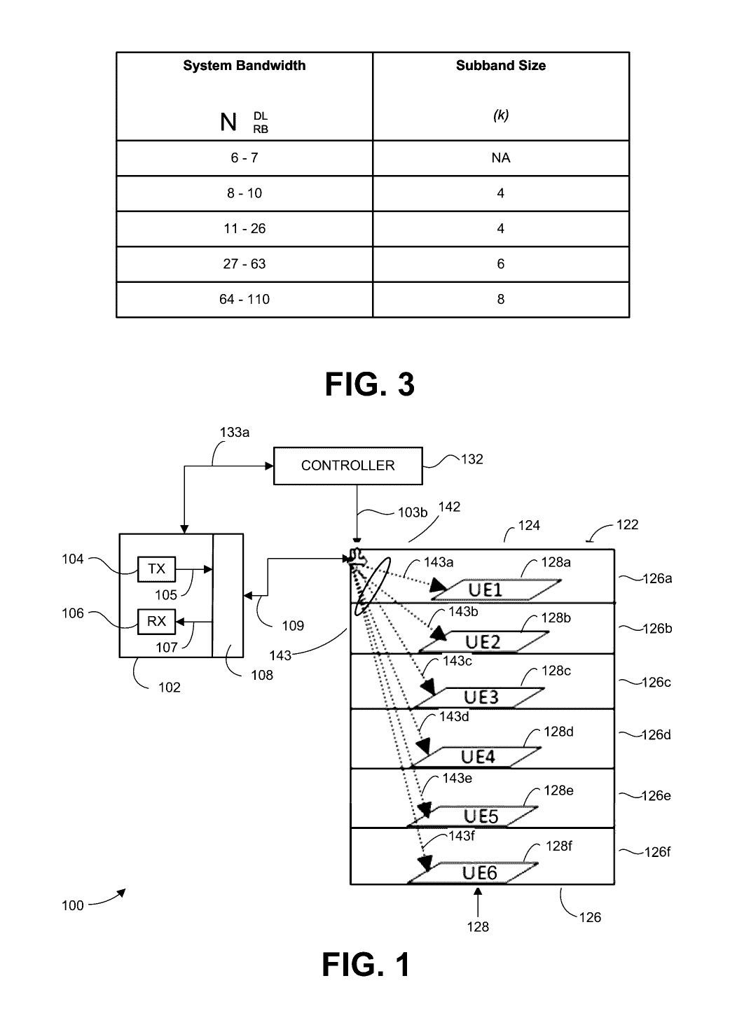

Referring to FIG. 1, an exemplary embodiment 100 of an OTA testing environment for using methods in accordance with the presently claimed invention will typically include a tester 102, a shielded testing enclosure 122 and a controller 132, interconnected substantially as shown. The tester 102 is designed to emulate operations of an access point, such as an evolved Node B of an LTE system, and will include transmitter circuitry 104, receiver circuitry 106 and signal routing circuitry 108 (e.g., signal switches, multiplexors, directional couplers or diplexors). The signal routing circuitry 108 conveys the transmitter signals 105 to a bidirectional signal path 109 via which signals 107 received from devices being tested are also conveyed and routed by the signal routing circuitry 108 to the receiver circuitry 106. The bidirectional signal path 109 is typically a conductive signal path in the form of RF cables and connectors, to the testing enclosure 122.

The testing enclosure 122 includes a shielded enclosure 124 defining an interior region 126 which is organized, e.g., divided into multiple subsections or otherwise defined locations or positions 126a, 126b, . . . , for positioning the DUTs 128 for testing. For example, the testing locations 126a, 126b, . . . can be shelves or slots in which the individual DUTs 128 are placed during wireless testing.

The transmitter signals 105 from the tester 102, conveyed via the signal path 109, are radiated by an antenna system 142 to produce a radiated RF signal 143 having multiple signal components 143a, 143b, . . . intended for reception and processing by the respective DUTs 128a, 128b, . . . . The antenna system 142 can be a simple fixed antenna or antenna array with multiple elements, or alternatively, can be an antenna array capable of being controlled to perform beam steering in such a manner as to concentrate more of the radiated signal energy in the DUT locations 126 when desired. Control signals 143b are provided by the controller 132 when such signal steering is desired.

The controller 132 also exchanges instructions and data 133a with the tester 102 for controlling the testing operations of the tester 102 and its communications with the DUTs 128.

As noted above, such a wireless test enclosure 122, notwithstanding the use of anechoic designs within the interior region 126, will still provide an environment in which multipath effects will result in interference between or self-interference among the test signals between the antenna system 142 and DUTs 128. Hence, for example, the first DUT 128a will not simply receive a simple test signal 143a, but, rather, will receive the main test signal component 143a plus reflected signals (not shown), which will arrive from potentially many different directions with many different phases at the antenna system of the DUT (not shown). In accordance with the presently claimed invention, however, an existing feature and characteristic of the wireless signal standard (e.g., the LTE standard for purposes of this discussion) can be used to allocate signal resources for the test signals 143 to the respective DUTs 128a, b, . . . in such a way as to ensure reliable signal connections and maximize data throughput.

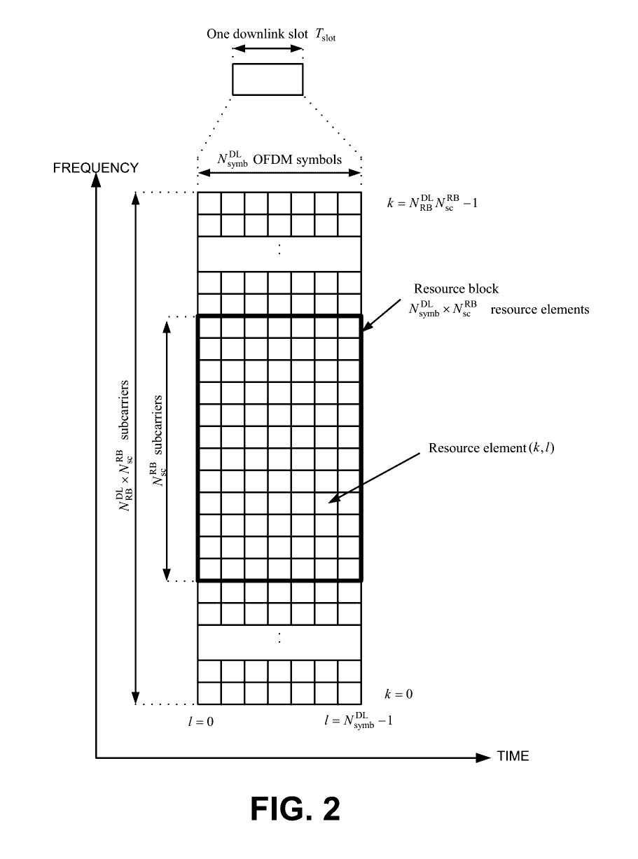

Referring to FIG. 2, as is well known in the art of wireless signal technology, wireless service providers and mobile phones operate in different frequency bands using different forms of signals. In the case of LTE, orthogonal frequency division multiple axis (OFDMA) signals are used, with the frequency band divided into orthogonal sub-carriers. Such signals are composed of resource elements (REs) grouped together in resource blocks (RBs), as shown, with the horizontal axis (abscissa) representing the time domain and the vertical axis (ordinate) representing the frequency domain. In the time domain, each unit is a slot, with a duration of 0.5 milliseconds, and in the frequency domain, each unit is a OFDMA sub-carrier. One slot in the time domain and 12 sub-carriers in the frequency domain form a resource block. Sub-bands are formed by grouping multiple resource blocks together.

Referring to FIG. 3, system bandwidth N is function of sub-band size k, with relationships between system bandwidth (megahertz) and sub-band k as shown.

In accordance with the presently claimed invention, these characteristics of resource elements, resource blocks and sub-bands can be advantageously leveraged to ensure the reliable communications are established and maintained between the tester 102 and individual DUTs 128 by using channel quality information (CQI) that the LTE devices self-report for individual sub-bands. The tester 102 uses the CQI data to allocate downlink resources across specific sub-bands by transmitting signals with transmission block sizes (groups of resource blocks) selected along with modulation (e.g., quadrature phase shift keying (QPSK), four-bit quadrature amplitude modulation (16 QAM), or six-bit quadrature amplitude modulation (64 QAM)), selected in accordance with the CQI data (discussed in more detail below).

As is well-known, in accordance with the LTE standard, access point and mobile devices use a number of different channels for communications, among which four important channels include a physical downlink control channel (PDCCH), a physical uplink control channel (PUCCH), a physical downlink shared channel (PDSCH) and a physical uplink shared channel (PUSCH). The mobile devices transmit CQI data in one of these two uplink channels, i.e., either the uplink control channel or uplink shared channel, depending upon whether there is a shared channel allocation.

As discussed in more detail below, the CQI data reported by the mobile devices can be used to enable the tester 102 (FIG. 1) to adjust calibrations of the sub-bands of the test signals 143 transmitted to the DUTs 128, thereby simulating, within the shielded enclosure 122, a significantly improved, if not ideal, signal condition for OTA testing of the individual DUTS 128. This can be accomplished by first acquiring a known good device (KGD), i.e., a device similar to or at least representative of the DUTs 128 to be tested, and configured it to report CQI data for all sub-bands individually. For any of the sub-bands not reported by the KGD to the tester 102 as having been correctly received, then, based upon the CQI data reported by the KGD, the tester 102 can re-configure its signal parameters (e.g., transport block size, modulation, etc.) for such sub-band not reported as having been correctly received to effectively calibrate signals transmitted for that particular sub-band for a future DUT when placed in that test location 126.

In other words, a calibration procedure can be designed (e.g., in which an algorithm is designed for what and how test signals are provided) to compensate for multipath effects related to the position of a DUT 128 within the enclosure 122 and its position relative to the antenna system 142. Parameters of such a procedure will depend on the positions and the number of DUTs 128. As discussed in more detail below, channel quality indicator (CQI) data can be used to determine sub-band conditions for a DUT that is placed in different locations within the test enclosure 122. The calibration procedure can then be constructed such that it provides a reasonable approximation based on measurements performed using a KGD as the calibration DUT in any position based on the wideband and sub-band CQI data provided by the KGD after it communicates from within the enclosure 122 with the tester 102 via antenna system 142.

Such calibration procedure can then be adjusted by the CQI data of the KGD after being placed in any test position 126a, 126b, . . . (FIG. 1). The testing system 100 can then be further fine-tuned for a particular model of DUT with the KGD placed in each position 126. The other positions 126 can be occupied by identical model DUTs during such fine-tuning process. Once completed, DUTs can be placed in the test positions 126 and tested with confidence that test results are based, at least primarily, on DUT condition and not effects of multipath interference.

In the event that a different model of DUT is to be tested, this procedure can be repeated with CQI data from a KGD of that model of DUT to again calibrate the test system 100 for testing of such different DUTs.

For example, with the KGD positioned in the first test location 126a, the tester 102 establishes communication with the KGD 128a and, based upon the reported sub-band CQI data, configures signal parameters (e.g., modulation, coding and transport block size) for each of the sub-bands to maximize accuracy and throughput. Then, the KGD is moved to each of the remaining test locations 126b, 126c, 126d, 126e, 126f and this process is repeated. As a result, the tester 102 has a set of signal parameters for communicating with the DUTs in each of the test locations 126a, 126b, . . . within the OTA test enclosure 122.

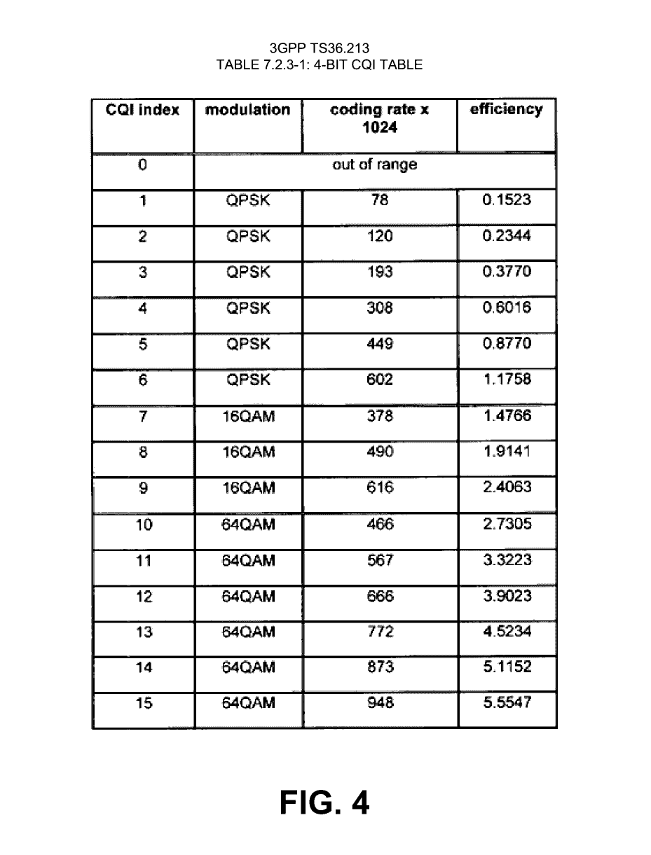

Referring to FIG. 4, the CQI data contains information sent from the mobile device to the access point to indicate a suitable downlink transmission data rate, generally referred to as a modulation and coding scheme (MCS) value. The CQI data is a four-bit integer and is based on the observed signal-to-interference-plus-noise ratio (SINR) within the mobile device. The process of estimating CQI also accounts for various capabilities of the mobile device, such as the number of antennas it has and the type of RF signal receiver used for detection. The resulting CQI data that is reported is then used by the access point for downlink schedule and link adaptation. A reporting of sub-band CQI data includes a vector of CQI values where each CQI value is representative of the SINR observed by the mobile device over-band. As is well known, a sub-band is a collection of adjacent physical resource blocks (PRBs), where the number of PRBs can be two, three, four, six or eight, depending upon the channel bandwidth and the CQI feedback mode. Hence, CQI provides information how good or bad the communication channel quality is.

For LTEs systems, 15 CQI index values enable mapping between CQI, modulation scheme and transport block size, as shown. Once a CQI index value established, it is then necessary to determine the number of resource blocks and MCS for that index value to properly allocate the resources for communicating with a mobile device. With the modulation scheme information in the table, you can establish a range of MCS that would be useful for each CQI index. However, to determine a specific MCS and number of resource blocks, the code rate is needed. By performing a throughput calculation using data available in the LTE standard, the number of resource blocks, modulation and coding scheme, and transport block size can be computed.

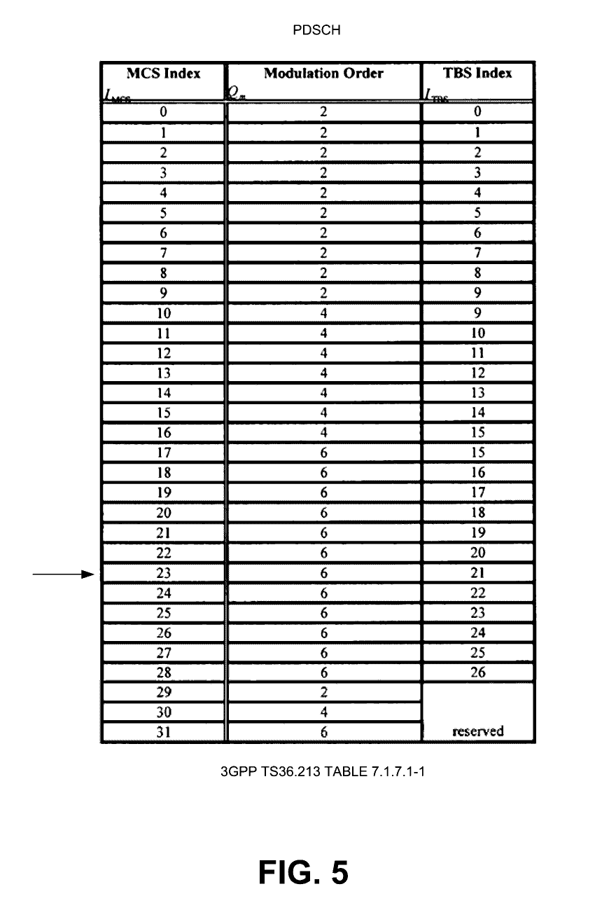

Referring to FIG. 5, the physical layer throughput in bits can be determined as the number of bits in the transport block size multiplied by the number of transport blocks as follows. For example, assuming an initial MCS value of 23 has been established, the transport block size index (TBS) for the downlink shared channel is 21.

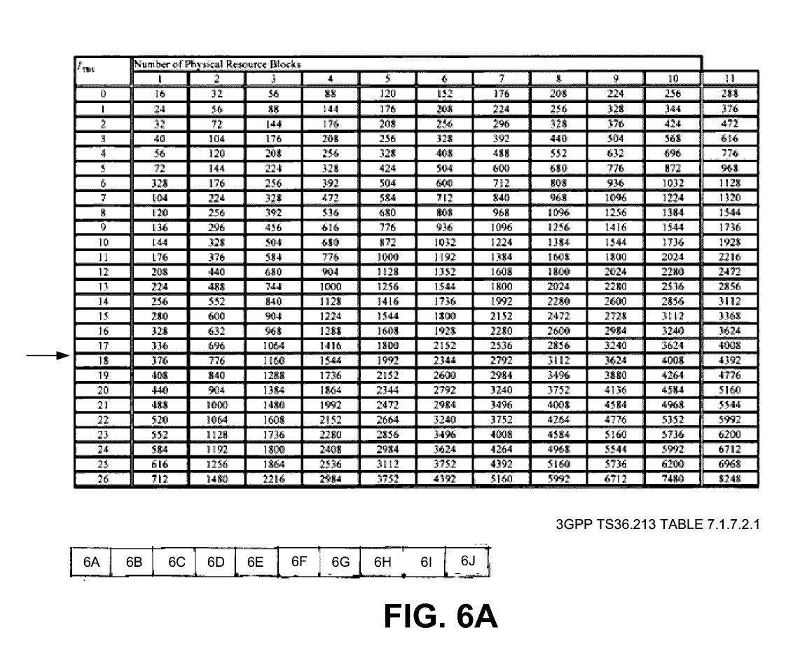

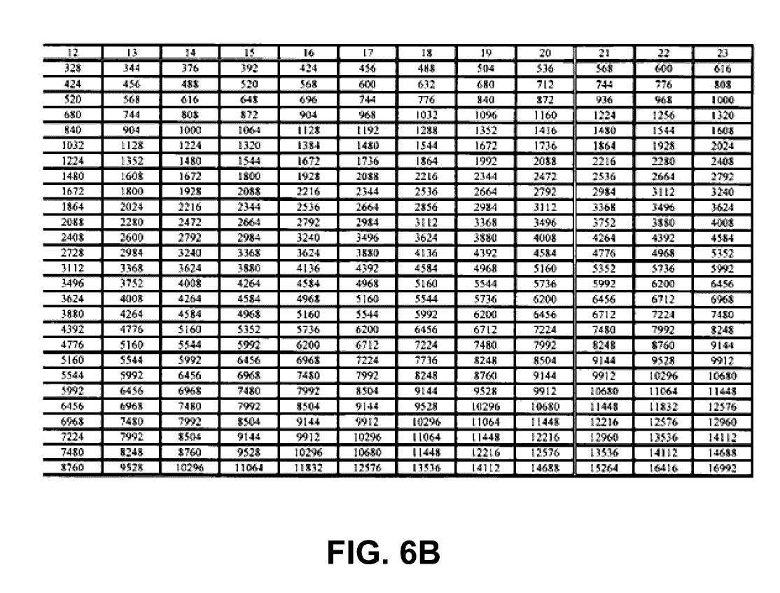

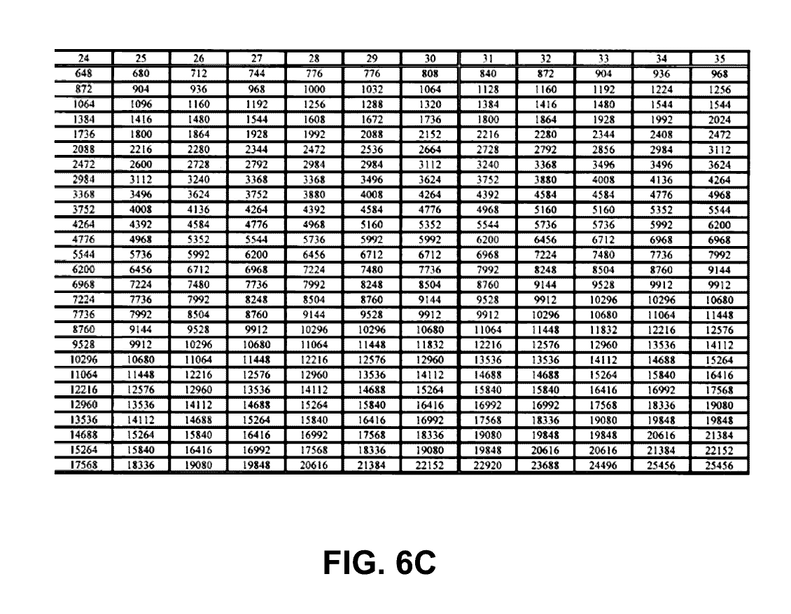

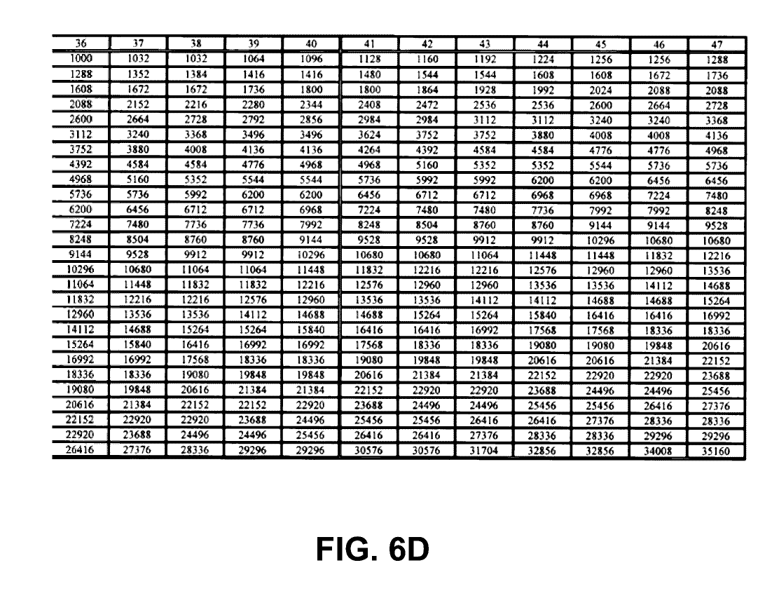

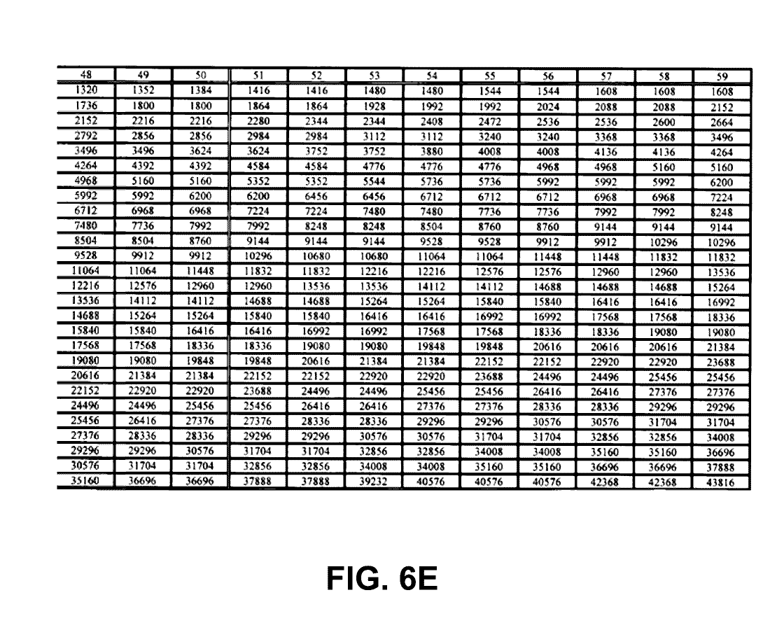

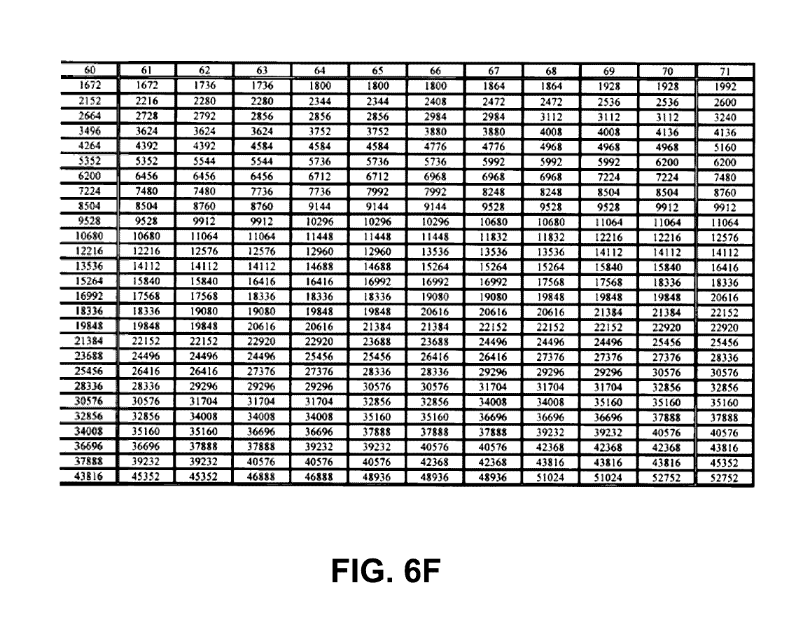

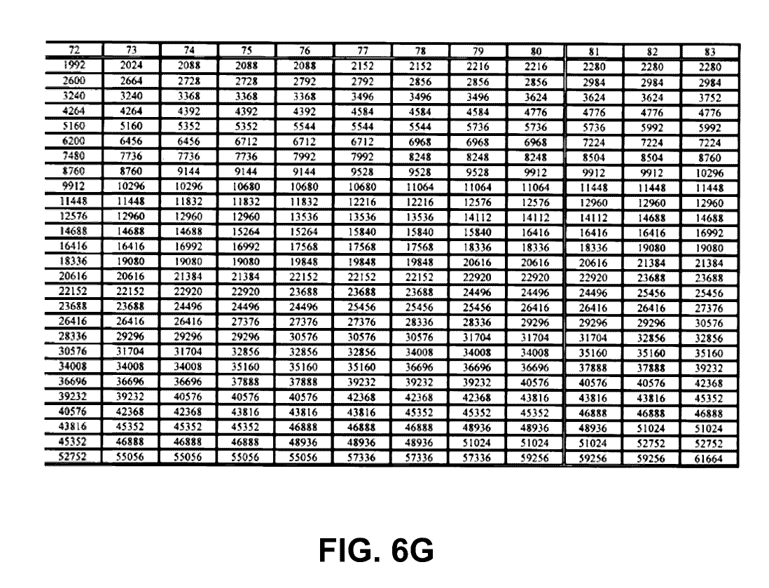

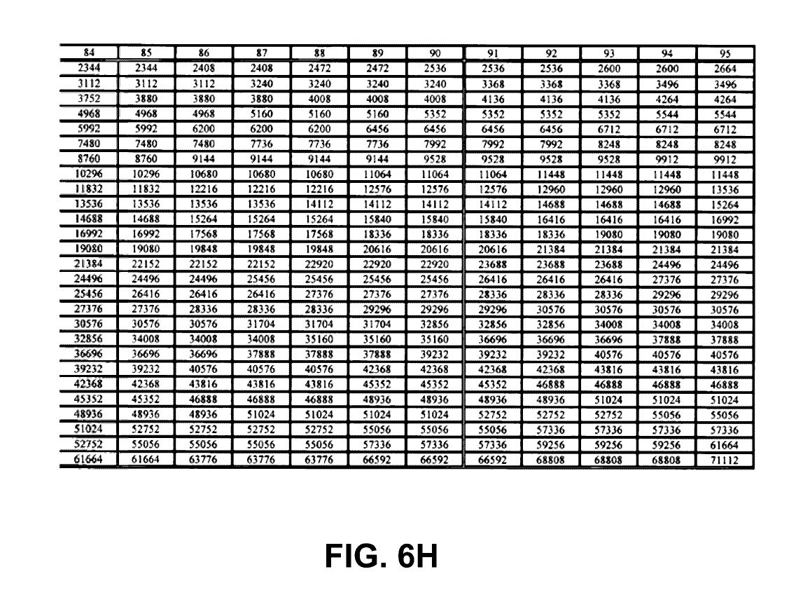

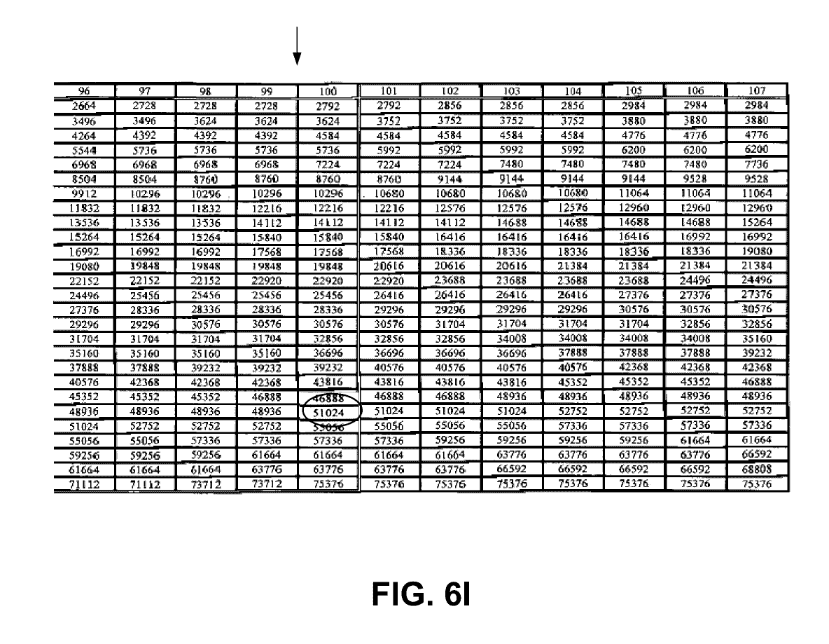

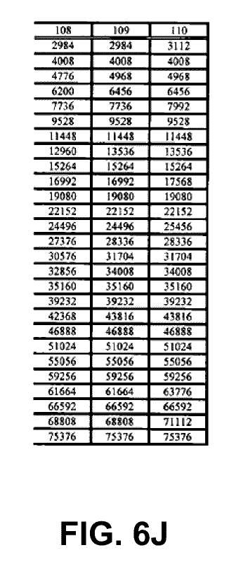

Referring to FIGS. 6A and 6I, the row corresponding to the TBS index 21 is located (FIG. 6A), as is the column for the number of resource blocks, which for this example is assumed 100 (FIG. 61). There it is found that the transport block size is 51,024 bits (for this example of a TBS index 21 and 100 resource blocks). This is the transport block size per one millisecond for one antenna. If two antennas are used the throughput will be 51,024 bits multiplied by two transport blocks (plus multiplied by 1,000 sub-frames per second), or approximately 100 megabits per second.

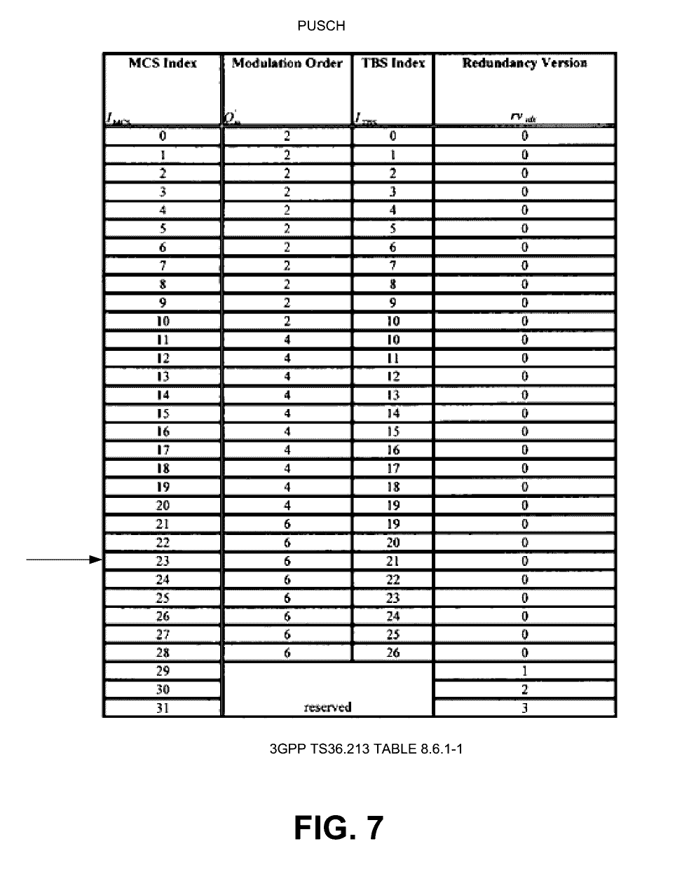

Referring to FIG. 7, a similar computation can be performed for the uplink, e.g., beginning with an initial MCS value of to determine the transport block size index (TBS) for the uplink shared channel.

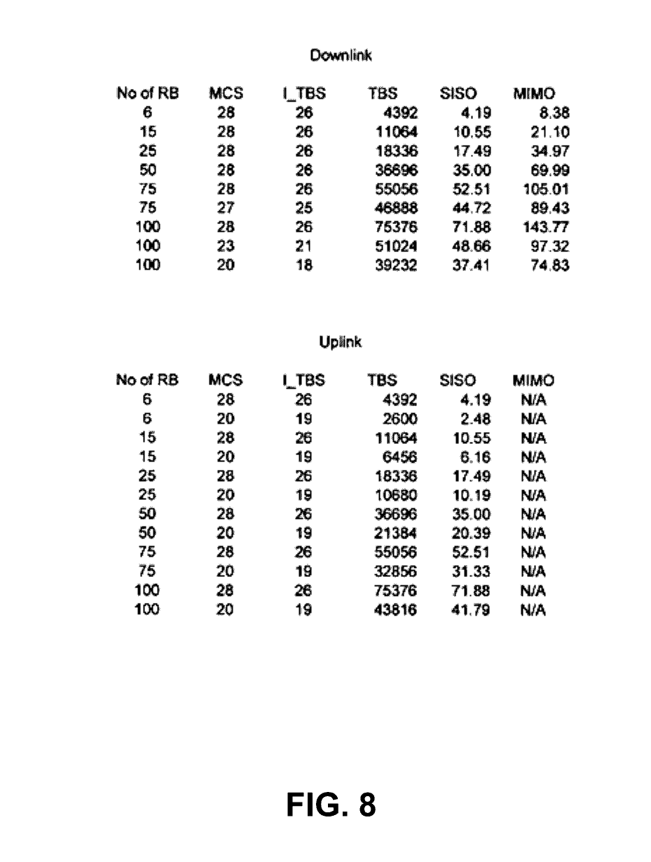

Referring to FIG. 8, examples can be found for determining downlink and uplink resource allocations using the procedure describe above.

Various other modifications and alterations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method for calibrating an over-the air (OTA) test system for testing a plurality of radio frequency (RF) data packet signal transceiver devices under test (DUTs), comprising:
providing an OTA test environment including a structure defining interior and exterior regions and one or more RF antennas disposed to transmit and receive radiated RF signals into and from said interior region, respectively, and configured to enable placement of a plurality of DUTs at locations within said interior region substantially isolated from electromagnetic radiation originating from said exterior region;
placing a known good device (KGD) in a defined location within said interior region;
transmitting, into said interior region via said one or more RF antennas, a RF test signal having a RF test signal band including a plurality of RF test signal sub-band channels to convey a plurality of encoded data symbols, wherein
each one of said plurality of RF test signal sub-band channels includes a plurality of serial time slots each of which contains one or more RF data signals, and
respective portions of said plurality of RF test signal sub-band channels include mutually distinct combinations of data bit modulation and quantity of data bits;
receiving, with said KGD, said RF test signal and in response thereto transmitting, with said KGD, a RF DUT signal including a plurality of channel quality information (CQI) data related to said defined location for at least a portion of said plurality of RF test signal sub-band channels, wherein respective portions of said plurality of CQI data are related to respective signal-to-interference-plus-noise ratios (SINRs) for corresponding portions of said plurality of RF test signal sub-band channels; and
placing said known good device (KGD) in another defined location within said interior region, followed by repeating said
transmitting, into said interior region via said one or more RF antennas, a RF test signal, and
receiving, with said KGD, said RF test signal and in response thereto transmitting, with said KGD, a RF DUT signal.

2. The method of claim 1, wherein said CQI data is related to decoding by said KGD of said plurality of encoded data symbols.

3. The method of claim 1, wherein said one or more RF data signals comprises a plurality of RF signal frequency subcarriers to convey said encoded data symbols.

4. The method of claim 1, wherein said KGD includes a number of antennas for receiving said RF test signal and transmitting said RF DUT signal, and said CQI data is related to said number of antennas.

5. The method of claim 1, wherein at least one of said SINRs is higher than one or more of other ones of said SINRs.

6. A method of using a calibrated over-the air (OTA) test system for testing a plurality of radio frequency (RF) data packet signal transceiver devices under test (DUTs), comprising:
providing an OTA test environment including a structure defining interior and exterior regions and one or more RF antennas disposed to transmit and receive radiated RF signals into and from said interior region, respectively, and configured for placement of a plurality of DUTs at corresponding defined locations within said interior region substantially isolated from electromagnetic radiation originating from said exterior region;
placing said plurality of DUTs at said corresponding defined locations;
transmitting, into said interior region via said one or more RF antennas, a RF test signal having a RF test signal band including a plurality of RF test signal sub-band channels to convey a plurality of encoded data symbols, wherein
each one of said plurality of RF test signal sub-band channels includes a plurality of serial time slots each of which contains one or more RF data signals, and
respective portions of said plurality of RF test signal sub-band channels include mutually distinct combinations of data bit modulation and number of data bits; and
receiving, with each one of said plurality of DUTs, at least a respective portion of said RF test signal including one or more combinations of data bit modulation and number of data bits associated with said corresponding defined location, and in response thereto transmitting, with said each one of said plurality of DUTs, a RF DUT signal.

7. The method of claim 6, wherein said one or more combinations of data bit modulation and number of data bits associated with said corresponding defined location are associated with said corresponding defined location in accordance with channel quality information (CQI) data related to said at least a respective portion of said RF test signal received at said defined location.

8. The method of claim 6, wherein said one or more combinations of data bit modulation and number of data bits associated with said corresponding defined location are associated with said corresponding defined location in accordance with one or more signal-to-interference-plus-noise ratios (SINRs) for said at least a respective portion of said RF test signal received by said DUT.

9. The method of claim 6, wherein said at least a respective portion of said RF test signal comprises a portion of said plurality of RF test signal sub-band channels.

10. The method of claim 6, wherein said at least a respective portion of said RF test signal including one or more combinations of data bit modulation and number of data bits associated with said corresponding defined location has a higher signal-to-interference-plus-noise ratio (SINR) when received by said DUT than another portion of said RF test signal including another one or more combinations of data bit modulation and number of data bits.
